(19) United States
(12) Patent Application Publication
(10) Pub. No.: US 2026/0268679 A1
(43) Pub. Date: Sep. 10, 2026

(54) SOCIAL ACTIVITY LEVEL DETECTION SYSTEM AND METHOD

(71) Applicant: NATIONAL CHENGCHI UNIVERSITY, Taipei City (TW)

(72) Inventors: Chao-Ling CHEN, Taipei City (TW); Qiong-Yue CHEN, Taipei City (TW); Kuan-Wu CHU, Taipei City (TW); Yin-Hsiang SU, Taipei City (TW)

(73) Assignee: NATIONAL CHENGCHI UNIVERSITY, Taipei City (TW)

(21) Appl. No.: 19/560,391

(22) Filed: Mar. 9, 2026

(30) Foreign Application Priority Data
Mar. 10, 2025 (TW) 114108764

(51) Int. Cl. G06V 20/52; G06V 10/94; G06V 40/16; G06V 40/20; G10L 15/26; G10L 25/63

(52) U.S. Cl. CPC G06V 20/52; G06V 10/95; G06V 40/176; G06V 40/20; G10L 15/26; G10L 25/63

(57) ABSTRACT

A social activity level detection system includes a data capturing apparatus and a server. The server performs: receiving an audio signal and an image from the data capturing apparatus; performing speech-to-text processing and a word count calculation on the audio signal to generate a speech word count; generating a speech vector based on a word count threshold and the speech word count; performing face detection and a person count calculation on the image to generate a field person count; generating a personnel vector based on a person count threshold and the field person count; performing a face recognition, an emotion recognition, and a summation scale adjustment on the image to generate a collective emotion vector; performing an element-wise addition operation on the speech vector, the personnel vector, and the collective emotion vector to generate a field emotion vector; converting the field emotion vector into a social temperature value.

### CROSS-REFERENCE TO RELATED APPLICATION

This application claims benefit of priority to Taiwanese Patent Application No. 114108764 filed Mar. 10, 2025, the entire contents of which are incorporated herein by reference.

### BACKGROUND OF THE DISCLOSURE

### Technical Field

The present disclosure relates to a technology for monitoring social interactions, and more particularly relates to a social activity level detection system and method.

### Description of Related Art

Although the current techniques employ a lot of methods to track and analyze the human group behavior patterns, emotional changes, and social interactions, these techniques usually focus on measuring the individual emotions or the physiological responses (e.g., the heart rate variability, the skin conductance, or the semantic analysis), and often fail to effectively integrate and quantify such data and the social activity level. In particular, in the field of the social interaction monitoring, there is currently no established method for measuring or quantifying the social activity level, which makes the existing monitoring systems be unable to accurately reflect the social interaction intensity or the emotional atmosphere within the human group. Accordingly, accurately quantifying the social activity level of the human group within the same field remains a problem that those skilled in the art urgently seek to solve.

### SUMMARY OF THE INVENTION

The primary objective of the present disclosure is to provide a social activity level detection system and method capable of accurately quantifying the social activity level of a human group based on the behavior patterns, the emotional variations, and the social interactions.

To achieve the above objective, the present disclosure provides a social activity level detection system, including:
a data capturing apparatus, disposed in a field, and configured to capture an audio signal in the field and capture an image of the field; and
a server, connected to the data capturing apparatus, and configured to perform the following operations:
operation a) receiving the audio signal and the image from the data capturing apparatus;
operation b) performing a speech-to-text processing and a word count calculation on the audio signal to generate a speech word count, and generating a speech vector based on a word count threshold and the speech word count;
operation c) performing a face detection and a person count calculation on the image to generate a field person count of a plurality of persons in the field, and generating a personnel vector based on a person count threshold and the field person count;
operation d) performing a face recognition and an emotion recognition (i.e., facial expression recognition) on the image to generate a personal emotion vector for each of a plurality of the persons in the field, and performing a summation scale adjustment on a plurality of the personal emotion vectors to generate a collective emotion vector; and
operation e) performing an element-wise addition operation on the speech vector, the personnel vector, and the collective emotion vector to generate a field emotion vector, and converting the field emotion vector into a social temperature value indicating a social activity level of a plurality of the persons in the field.

To achieve the above objective, the present disclosure provides a social activity level detection method, including:
step a) by a server, receiving an audio signal captured in a field and an image captured in the field from a data capturing apparatus;
step b) by the server, performing a speech-to-text processing and a word count calculation on the audio signal to generate a speech word count, and generating a speech vector based on a word count threshold and the speech word count;
step c) by the server, performing a face detection and a person count calculation on the image to generate a field person count of a plurality of persons in the field, and generating a personnel vector based on a person count threshold and the field person count;
step d) by the server, performing a face recognition and an emotion recognition on the image to generate a personal emotion vector for each of a plurality of the persons in the field, and performing a summation scale adjustment on a plurality of the personal emotion vectors to generate a collective emotion vector; and
step e) by the server, performing an element-wise addition operation on the speech vector, the personnel vector, and the collective emotion vector to generate a field emotion vector, and converting the field emotion vector into a social temperature value indicating a social activity level of a plurality of the persons in the field.

Compared with the prior techniques, the present disclosure combines various speech algorithms and computer vision algorithms to quantify the vectors corresponding to the number of the persons in a field, the speech word count, and the emotions from the audio signal and the image, and then converts the vectors into the social temperature value. Accordingly, the present disclosure may accurately quantify the social activity level of a human group within the same field.

### BRIEF DESCRIPTION OF THE DRAWINGS

FIG. 1A illustrates a block diagram of a social activity level detection system in some embodiments of the present disclosure.

FIG. 1B illustrates a schematic diagram of a field in some embodiments of the present disclosure.

FIG. 1C illustrates a schematic diagram of a field in other embodiments of the present disclosure.

FIG. 2 illustrates a flowchart of a social activity level detection method in some embodiments of the present disclosure.

FIG. 3 illustrates a schematic diagram of a two-dimensional emotion model in some embodiments of the present disclosure.

### DETAILED DESCRIPTION

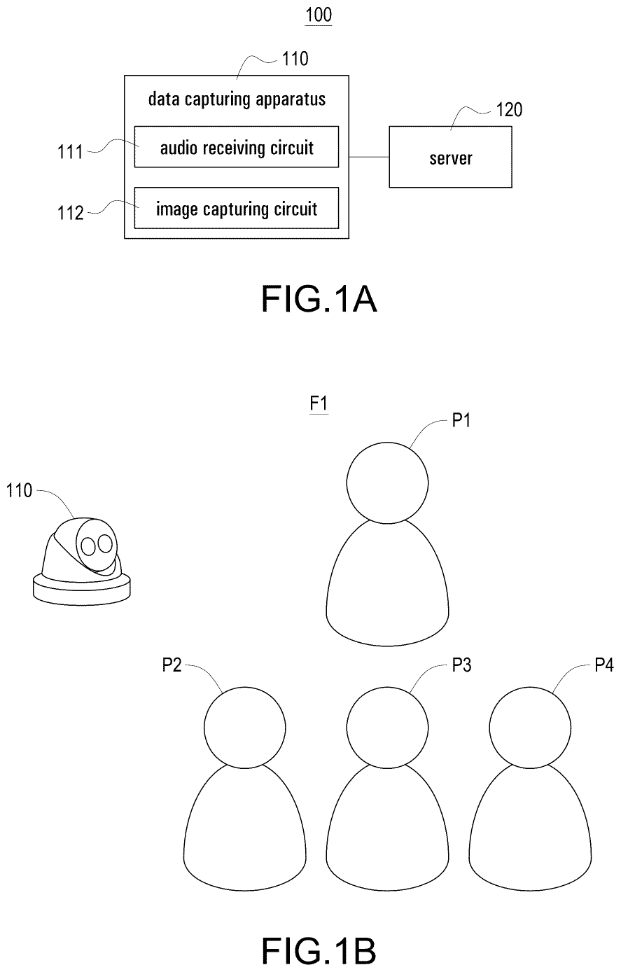

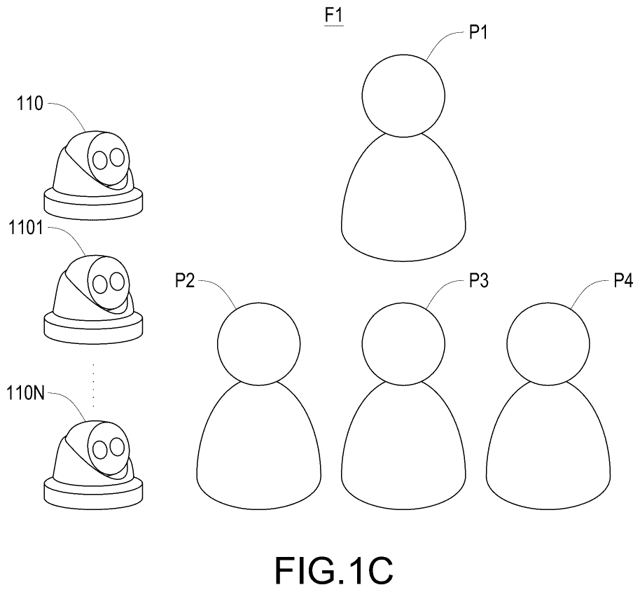

Referring to FIG. 1A, FIG. 1A illustrates a block diagram of a social activity level detection system 100 in some embodiments of the present disclosure. As shown in FIG. 1A, in the present embodiment, the social activity level detection system 100 includes a data capturing apparatus 110 and a server 120. The server 120 is connected to the data capturing apparatus 110.

In some embodiments, the data capturing apparatus 110 may be implemented by any apparatus having audio recording and video capturing functions (e.g., a smartphone, digital camera, wide-angle camera, digital video camera, action camera, notebook computer, or the like). In the present embodiment, the data capturing apparatus 110 is disposed in a field and is configured to acquire an audio signal in the field and to capture an image of the field. In other words, a user may utilize the data capturing apparatus 110, which is disposed in a specific field, to simultaneously acquire the audio signal in the field and capture the image of the field.

In some embodiments, the data capturing apparatus 110 may simultaneously acquire the audio signal in the field and capture the image of the field during the detection period. In some embodiments, the detection period may be preset by a user (e.g., preset to 10 seconds). In some embodiments, the data capturing apparatus 110 may be disposed at any location within the field that is capable of capturing the entire field. In some embodiments, the field mentioned above may be any social activity location in which persons may be present (e.g., a residence, conference room, supermarket, department store, lounge, social hall, or the like).

The data capturing apparatus 110 disposed in the field is described below with reference to a practical embodiment. Referring also to FIG. 1B, FIG. 1B illustrates a schematic diagram of a field F1 in some embodiments of the present disclosure. As shown in FIG. 1B, in the present embodiment, the data capturing apparatus 110 may be a wide-angle camera having the audio capturing function, and is disposed at a location in the field F1 that is capable of capturing the entire field F1. Assume that four persons P1-P4 are currently present in the field F1 conducting a meeting discussion. The data capturing apparatus 110 acquires the audio signal corresponding to the speech of the persons P1-P4 and captures the image of the field F1 in which the persons P1-P4 are present.

Referring also to FIG. 1C, FIG. 1C illustrates a schematic diagram of a field F1 in other embodiments of the present disclosure. As shown in FIG. 1C, in the present embodiment, compared with the embodiment of FIG. 1B, the field F1 may be further equipped with a plurality of additional data capturing apparatuses 1101-110N, which may be disposed at other locations in the field F1 that are capable of capturing the entire field F1, wherein N may be any positive integer. Accordingly, the data capturing apparatuses 110 and 1101-110N may capture the persons P1-P4 from more capturing angles and acquire the audio of the persons P1-P4 from more capturing angles. In other embodiments, a portion of the data capturing apparatuses (e.g., the data capturing apparatuses 110, and 1101-1103) may be the apparatuses having only the audio capturing function (e.g., a microphone array), while another portion of the data capturing apparatuses (e.g., the data capturing apparatuses 1104-110N) may be the apparatuses having only the video capturing function (e.g., the digital cameras).

Based on this, performing various image processing and audio processing described in the following paragraphs on more images and more audio signals may greatly improve the accuracy and efficiency of these image and audio processing operations. It is noted that, in order to more clearly explain how to perform the social activity level detection method in the following paragraphs, a single data capturing apparatus 110 continues to be used as an embodiment for illustration in the following paragraphs. In addition, although four persons P1-P4 are used as an embodiment herein, in practice, more persons may be present in the field F1.

Referring back to FIG. 1A, in some embodiments, the data capturing apparatus 110 includes an audio receiving circuit 111 and an image capturing circuit 112. The audio receiving circuit 111 is configured to detect sounds in the field to generate audio signals. The image capturing circuit 112 is configured to capture images of the field. In some embodiments, the audio receiving circuit 111 may be implemented by an audio amplifier, a wireless audio receiver, a microphone array, or a combination thereof. In some embodiments, the image capturing circuit 112 may be implemented by a wide-angle image capturing circuit, a digital image capturing circuit, an optical image capturing circuit, a stereoscopic image capturing circuit, a thermal image capturing circuit, a radar image capturing circuit, or a combination thereof.

In the present embodiment, the server 120 receives the audio signal and the image from the data capturing apparatus 110, and utilizes the audio signal and the image to perform the social activity level detection method described in the following paragraphs (described later). In some embodiments, the server 120 may be implemented by any server having high data processing capability (e.g., a cloud server, virtual server, rack-mounted server, or the like).

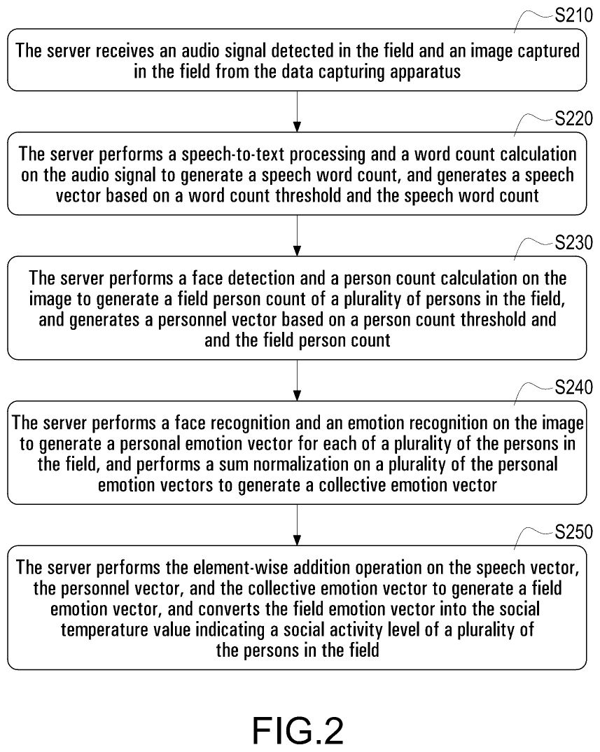

Referring also to FIG. 2, FIG. 2 illustrates a flowchart of the social activity level detection method in some embodiments of the present disclosure. This social activity level detection method is applicable to the social activity level detection system 100 shown in FIGS. 1A-1C. As shown in FIG. 2, the social activity level detection method includes steps S210-S250.

First, in step S210, the server 120 receives an audio signal acquired in the field F1 and an image captured in the field F1 from the data capturing apparatus 110. In step S220, the server 120 performs a speech-to-text processing and a word count calculation on the audio signal to generate a speech word count, and generates a speech vector based on a word count threshold and the speech word count.

In some embodiments, the speech-to-text (STT) processing may be implemented by any algorithm configured to accurately map linguistic units (e.g., syllables, words, or the like) in speech to corresponding textual forms (e.g., the whisper-small model proposed by OpenAI, the hidden Markov model (HMM), the Gaussian mixture model (GMM), the long short-term memory (LSTM) model, or the like). In some embodiments, the word count threshold may be preset by a user or obtained based on statistical results from a plurality of experiments (e.g., the social activity level is generally higher when all persons in the field F1 speak sentences containing more than 15 words within 10 seconds; therefore, the word count threshold may be set to 15).

In some embodiments, the server 120 performs the speech-to-text processing on the audio signal to generate a plurality of speech texts, and performs the word count calculation on a plurality of the speech texts to generate the speech word count. Subsequently, the server 120 compares the speech word count with the word count threshold to obtain a comparison result, and generates the speech vector from a two-dimensional emotion model based on the comparison result. In some embodiments, when the comparison result indicates that the speech word count is greater than the word count threshold, the server 120 sets a high-arousal vector on an arousal axis of the two-dimensional emotion model as the speech vector. Conversely, when the comparison result indicates that the speech word count is not greater than the word count threshold, the server 120 sets a low-arousal vector on the arousal axis of the two-dimensional emotion model as the speech vector.

In some embodiments, the two-dimensional emotion model may be implemented by any two-dimensional emotional dimensional model (e.g., Russell's circumplex model of emotion, Plutchik's wheel of emotions, or the like). In some embodiments, the two-dimensional emotion model is a two-dimensional space established by a vertical arousal axis and a horizontal valence axis. In some embodiments, a vector pointing more toward the positive direction of the valence axis in the two-dimensional emotion model corresponds to an emotion with higher valence, whereas a vector pointing more toward the negative direction of the valence axis in the two-dimensional emotion model corresponds to an emotion with lower valence. In some embodiments, a vector pointing more toward the positive direction of the arousal axis in the two-dimensional emotion model corresponds to an emotion with higher arousal, whereas a vector pointing more toward the negative direction of the arousal axis in the two-dimensional emotion model corresponds to an emotion with lower arousal.

In some embodiments, the two-dimensional emotion model includes a plurality of feature vectors. A plurality of the feature vectors respectively correspond to a plurality of emotional features (e.g., happy, surprise, fear, anger, disgust, sad, and neutral). In some embodiments, a vector in the two-dimensional emotion model has a vector angle with reference to the negative direction of the valence axis, and this vector angle is proportional to a social temperature value of the vector (i.e., the social temperature value proposed in Russell's theory). A plurality of quadrants of the two-dimensional emotion model respectively correspond to a plurality of temperature ranges (e.g., 0-10 degrees, 10-20 degrees, 20-30 degrees, and 30-40 degrees).

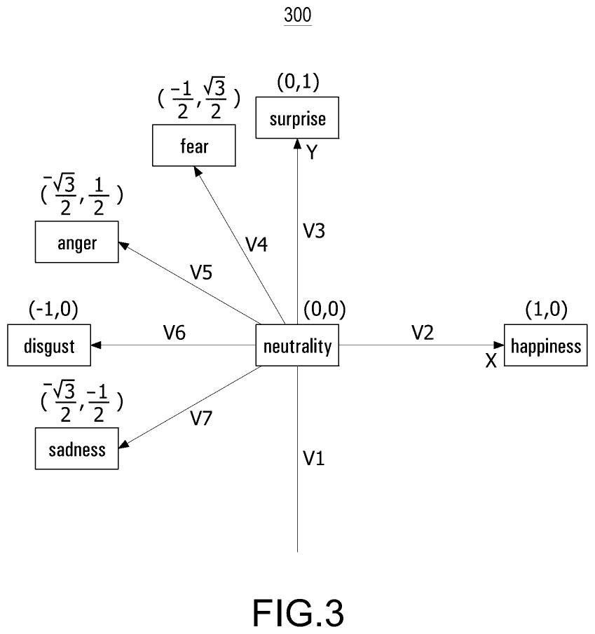

The two-dimensional emotion model is described below with reference to a practical embodiment. Reference is also made to FIG. 3, which illustrates a schematic diagram of the two-dimensional emotion model 300 in some embodiments of the present disclosure. As shown in FIG. 3, the two-dimensional emotion model 300 is Russell's circumplex model of emotion. The X-axis of the two-dimensional emotion model 300 represents the valence axis, while the Y-axis of the two-dimensional emotion model 300 represents the arousal axis. The four quadrants of the two-dimensional emotion model 300 correspond to 0-10 degrees, 10-20 degrees, 20-30 degrees, and 30-40 degrees, respectively. The two-dimensional emotion model 300 includes a plurality of feature vectors V1-V7, which correspond to 7 emotional features respectively. The 7 emotional features include happiness, surprise, fear, anger, disgust, sadness, and neutrality.

Moreover, the starting points of the feature vectors V1-V7 are all at the origin. The coordinates of the endpoint of the feature vector V1 are (0, 0). The coordinates of the endpoint of the feature vector V2 are (1, 0). The coordinates of the endpoint of the feature vector V3 are (0, 1). The coordinates of the endpoint of the feature vector V4 are

$$( \frac{- 1}{2} , \frac{\sqrt{3}}{2} ) .$$

The coordinates of the endpoint of the feature vector V5 are

$$( \frac{- \sqrt{3}}{2} , \frac{1}{2} ) .$$

The coordinates of the endpoint of the feature vector V6 are (−1, 0). The coordinates of the endpoint of the feature vector V7 are

$$( \frac{- \sqrt{3}}{2} , \frac{- 1}{2} ) .$$

The vector angle (i.e., the included angle) between the feature vector V1 and the −X axis is 0 degrees. The vector angle between the feature vector V2 and the −X axis is 180 degrees. The vector angle between the feature vector V3 and the −X axis is 270 degrees. The vector angle between the feature vector V4 and the −X axis is 300 degrees. The vector angle between the feature vector V5 and the −X axis is 330 degrees. The vector angle between the feature vector V6 and the −X axis is 360 degrees. The vector angle between the feature vector V7 and the −X axis is 30 degrees.

Since the vector angle is proportional to the social temperature value of the vector, the social temperature value of the feature vector V1 with reference to the −X axis may be set to 0 degrees; the social temperature value of the feature vector V2 may be set to 20 degrees; the social temperature value of the feature vector V3 may be set to 30 degrees; the social temperature value of the feature vector V4 may be set to 33.33 degrees; the social temperature value of the feature vector V5 may be set to 36.67 degrees; the social temperature value of the feature vector V6 may be set to 40 degrees; the social temperature value of the feature vector V7 may be set to 3.33 degrees.

It is noteworthy that these emotional features and these corresponding emotion vectors may respectively correspond to a plurality of elements in the emotion recognition vector described in the paragraphs (e.g., 7 emotional features respectively correspond to 7 elements, and 7 corresponding feature vectors also respectively correspond to 7 elements). In some embodiments, these emotional features and these corresponding emotion vectors may be preset by the user or statistically obtained from a plurality of experiments. In other embodiments, in addition to the aforementioned emotional features and these corresponding emotion vectors, other emotional features (e.g., excitement) and other corresponding feature vectors (e.g., the starting point of the feature vector corresponding to excitement is at the origin, and the endpoint is at

$$( \frac{\sqrt{3}}{2} , \frac{1}{2} ) )$$

may also be set in the two-dimensional emotion model 300.

On the other hand, when the above comparison result indicates that the speech word count is greater than the word count threshold, the server 120 may set the vector on the Y-axis of the two-dimensional emotion model 300, having the starting point at the origin and the endpoint at (0, 1) (i.e., the high-arousal vector), as the speech vector mentioned above. Conversely, when the comparison result indicates that the speech word count is not greater than the word count threshold, the server 120 sets the vector on the Y-axis of the two-dimensional emotion model 300, having the starting point at the origin and the endpoint at (0, −1) (i.e., the low-arousal vector), as the speech vector. By this approach, the frequency of conversations among the persons in the field F1 may be quantified as a vector for use in calculating the social temperature value in the subsequent paragraphs.

Referring back to FIG. 2, in step S230, the server 120 performs a face detection and a person count calculation on the image to generate a field person count of a plurality of persons in the field F1, and generates a personnel vector based on a person count threshold and the field person count.

In some embodiments, the face detection may be implemented by any algorithm configured to recognize face objects from the image (e.g., the YOLOv8n model, the faster region-based convolutional neural network (faster R-CNN) model, the histogram of oriented gradients (HOG) algorithm, or the like). In some embodiments, the person count threshold may also be preset by the user or statistically obtained from a plurality of experiments (e.g., when the number of the persons in the field F1 is greater than 1 within 10 seconds, the social activity level increases; therefore, the person count threshold may be set to 1).

In some embodiments, the server 120 performs the face detection on the image to recognize a plurality of the face objects corresponding to a plurality of the persons in the image, and counts a plurality of the face objects to generate the field person count. Then, the server 120 compares the field person count with the person count threshold to generate a comparison result, and generates the personnel vector from the two-dimensional emotion model 300 based on the comparison result. In some embodiments, when the comparison result indicates that the field person count is greater than the person count threshold, the server 120 sets the high-arousal vector (e.g., a vector with the starting point at the origin and the endpoint at (0, 1)) on the arousal axis (i.e., the Y-axis) of the two-dimensional emotion model 300 as the personnel vector. Conversely, when the comparison result indicates that the field person count is not greater than the person count threshold, the server 120 sets the low-arousal vector (e.g., a vector with the starting point at the origin and the endpoint at (0, −1)) on the arousal axis of the two-dimensional emotion model 300 as the personnel vector. By this approach, the number of the persons in the field F1 may be quantified as a vector for use in calculating the social temperature value in the subsequent paragraphs.

In step S240, the server 120 performs a face recognition and an emotion recognition on the image to generate a personal emotion vector for each of a plurality of the persons in the field, and performs a summation scale adjustment on a plurality of the personal emotion vectors to generate a collective emotion vector.

In some embodiments, the face recognition may be implemented by any algorithm configured to perform the face identity recognition (e.g., the Dlib model, the FaceNet model, the ArcFace model, or the like). In some embodiments, the emotion recognition may be implemented by any algorithm configured to perform the emotion recognition (e.g., the VGG-face model, the deep residual network (ResNet) model, the multi-task learning (MTL) model, or the like). In some embodiments, the summation scale adjustment includes the element-wise addition operation and the scale adjustment according to the vector dimension (e.g., performing the element-wise addition operation on a plurality of the vectors with the dimension 7 to generate a vector sum, and then dividing all 7 elements in the vector sum by 7).

In some embodiments, the server 120 performs the face recognition on the image to generate an identity information for each of a plurality of the persons in the field F1. Then, the server 120 performs the emotion recognition on the image to generate an emotion recognition vector corresponding to each of the identity information. Subsequently, the server 120 converts the emotion recognition vector corresponding to each of the identity information into the personal emotion vector of the person corresponding to each of the identity information in the two-dimensional emotion model 300, respectively.

In some embodiments, the server 120 pre-stores a plurality of face feature sets and candidate identity information corresponding to each of a plurality of the face feature sets, and then performs the face recognition on the image based on these face features and the candidate identity information to generate the identity information for a plurality of the persons in the field F1 and face regions in the image corresponding to each of these identity information. In this way, the server 120 may determine which persons are currently present in the field F1 and engaged in social activities, and whether any persons not previously recorded are engaged in social activities in the field F1.

Subsequently, the server 120 further performs the emotion recognition on these face regions to generate the emotion recognition vector corresponding to each of the identity information, wherein a plurality of elements in each of the emotion recognition vectors respectively correspond to a plurality of emotional features, and a plurality of the emotional features respectively correspond to a plurality of the feature vectors in the two-dimensional emotion model 300 (e.g., the emotion recognition vector has 7 elements, the 7 elements respectively correspond to 7 emotional features in FIG. 3, and the 7 emotional features in FIG. 3 correspond to 7 feature vectors in the two-dimensional emotion model 300 in FIG. 3). In some embodiments, the value of each element in an emotion recognition vector indicates the probability that the expression of the person corresponding to the emotion recognition vector belongs to the emotional feature corresponding to that element (e.g., when the value of the element corresponding to happiness in an emotion recognition vector is 0.5, the probability that the expression of the person corresponding to the emotion recognition vector is happiness is 0.5).

In some embodiments, the server 120 performs a weighted average on a plurality of the feature vectors based on a plurality of the elements in the emotion recognition vector corresponding to each of the identity information to generate the personal emotion vector of the person corresponding to each of the identity information. In some embodiments, the server 120 uses a plurality of the elements in the emotion recognition vector corresponding to each of the identity information as a plurality of weights to perform the weighted average on a plurality of the feature vectors to generate a calculation result, and the calculation result is used as the personal emotion vector of the person corresponding to each of the identity information.

For example, based on the embodiment in FIG. 3, the server 120 may use the 7 elements in one of the personal emotion vectors corresponding to one of the identity information as 7 weights corresponding to the 7 feature vectors in the two-dimensional emotion model 300, respectively. The server 120 then multiplies the 7 weights with the 7 feature vectors respectively to generate 7 product vectors. Subsequently, the server 120 performs the element-wise addition operation on the 7 product vectors to generate the vector sum, and divides the vector sum by 7 to generate the personal emotion vector of the person corresponding to one of the identity information. By this approach, the expressions of all persons in the field F1 may be integrated and quantified into a vector for use in calculating the social temperature value in the subsequent paragraphs.

In step S250, the server 120 performs the element-wise addition operation on the speech vector, the personnel vector, and the collective emotion vector to generate a field emotion vector, and converts the field emotion vector into the social temperature value indicating a social activity level of a plurality of the persons in the field F1. In some embodiments, when the social temperature value is higher, the number of the persons in the field F1 is greater or the emotions of a plurality of the persons in the field F1 are more active. Conversely, when the social temperature value is lower, the number of the persons in the field F1 is smaller or the emotions of a plurality of the persons in the field F1 are more subdued. In some embodiments, the social temperature value has a preset temperature range (e.g., the temperature range of the social temperature value may be the same as the overall temperature range of the two-dimensional emotion model 300 (i.e., both are 0-40 degrees)).

In other embodiments, the server 120 may multiply three preset weights respectively with the speech vector, the personnel vector, and the collective emotion vector to generate a weighted speech vector, a weighted personnel vector, and a weighted collective emotion vector, and then perform the element-wise addition operation on the weighted speech vector, the weighted personnel vector, and the weighted collective emotion vector to generate the field emotion vector. In some embodiments, these preset weights may also be preset by the user or statistically obtained from a plurality of experiments.

In some embodiments, the server 120 generates the vector angle based on the field emotion vector with reference to the negative direction of the valence axis in the two-dimensional emotion model 300 (i.e., the included angle between the field emotion vector and the negative direction of the valence axis is taken as the vector angle). Then, the server 120 determines in which of a plurality of the quadrants in the two-dimensional emotion model 300 the vector angle is located to generate a determination result, and calculates the social temperature value based on the determination result and the vector angle.

In some embodiments, the server 120 calculates an angular difference between the vector angle and a starting angle of the quadrant indicated by the determination result (e.g., starting vectors of the first quadrant to the fourth quadrant in the two-dimensional emotion model 300 are on the X-axis, the Y-axis, the −X-axis, and the −Y-axis, respectively; the included angles between the X-axis, the Y-axis, the −X-axis, and the −Y-axis with the −X-axis are 180, 270, 0, and 90 degrees, respectively; these included angles may serve as the starting angles of the first quadrant to the fourth quadrant, respectively). The server 120 then calculates the social temperature value based on a number corresponding to the quadrant indicated by the determination result (e.g., the first quadrant to the fourth quadrant correspond to 0, 10, 20, and 30, respectively) and the angular difference. In some embodiments, the social temperature value is expressed by the following formula (1).

$$T = \{ \begin{matrix}0 + 10 \times \frac{D - 180}{90} , 180 \leq D < 270 \\ 10 + 10 \times \frac{D - 270}{90} , 270 \leq D < 360 \\ 20 + 10 \times \frac{D - 0}{90} , 0 \leq D < 90 \\ 30 + 10 \times \frac{D - 90}{90} , 90 \leq D < 180\end{matrix} \qquad formula ( 1 )$$

As shown in formula (1), T represents the social temperature value, and D represents the vector angle. The angle subtracted from the vector angle is the starting angle of the quadrant in which the vector angle mentioned above is located. In formula (1), a number added to a product

$$( e . g . , 10 \times \frac{D - 180}{90} )$$

is the number corresponding to the quadrant in which the vector angle mentioned above is located. Specifically, when the vector angle is in the first quadrant, the angular difference is D−180, the number corresponding to the first quadrant is 0, and the social temperature value is equal to

$$0 + 10 \times \frac{D - 180}{90} .$$

When the vector angle is in the second quadrant, the angular difference is D−270, the number corresponding to the second quadrant is 10, and the social temperature value is equal to

$$10 + 10 \times \frac{D - 270}{90} .$$

When the vector angle is in the third quadrant, the angular difference is D−0, the number corresponding to the third quadrant is 20, and the social temperature value is equal to

$$20 + 10 \times \frac{D - 0}{90} .$$

When the vector angle is in the fourth quadrant, the angular difference is D−90, the number corresponding to the fourth quadrant is 30, and the social temperature value is equal to

$$30 + 10 \times \frac{D - 90}{90} .$$

In some embodiments, when the social temperature value is greater than a temperature threshold, the server 120 may obtain, from the personal emotion vector of each of the persons, the emotional features corresponding to all elements greater than an emotion threshold, and display (e.g., on a display apparatus (not shown) or a monitoring apparatus (not shown) of the server 120) these emotional features corresponding to all elements greater than the emotion threshold. For example, when the display apparatus or the monitoring apparatus is a notebook computer disposed in the field F1, the display apparatus or the monitoring apparatus may receive these emotional features from the server 120 for display. In this way, the user may view the emotions exhibited by the persons in the field F1 when the social activity level is high. In some embodiments, the temperature threshold and the emotion threshold may also be preset by the user or statistically obtained from a plurality of experiments.

Through the above steps, the present disclosure may quantify the number of the persons in the field F1, the frequency of conversations among the persons, and the emotions of the persons into a plurality of vectors, and then convert these vectors into the social temperature value. In this way, the present disclosure may utilize the social temperature value to quantify both the number of the persons in the field F1 and the degree of the emotional activity, allowing the user to understand the current social activity level in the field F1 and to conduct the research in the field of the social interaction monitoring.

In summary, the social activity level detection system and method proposed in the present disclosure combine various speech algorithms and computer vision algorithms to quantify, from the audio signals and the images, the vectors corresponding to the number of the persons, the speech word count, and the emotions of the persons in the field, and then convert these vectors into the social temperature value. In this way, the social activity level detection system and method proposed in the present disclosure may determine the current social activity level of the field from the social temperature value. Moreover, the social activity level detection system and method proposed in the present disclosure utilizes the two-dimensional emotion model, commonly used in the social research, to convert the vectors into the temperature values to obtain the required social temperature value. In this manner, the present disclosure may utilize the social temperature value to allow the user to understand the current social activity level in the field F1 and to conduct the research in the field of the social interaction monitoring. In addition, the social activity level detection system and method proposed in the present disclosure may enable the user to further observe the results of the emotion recognition when the social temperature value is higher, thereby determining which emotions are present among the persons in the field when the social temperature value is higher.

Although the present disclosure has been described above with reference to exemplary embodiments, it is not intended to limit the present disclosure. Those skilled in the art, having ordinary knowledge in the relevant technical field, may make minor modifications and variations without departing from the spirit and scope of the present disclosure. Therefore, the scope of protection of the present disclosure should be defined by the appended claims.

What is claimed is:

1. A social activity level detection system, comprising:
a data capturing apparatus, disposed in a field, and configured to capture an audio signal in the field and capture an image of the field; and
a server, connected to the data capturing apparatus, and configured to perform the following operations:
operation a) receiving the audio signal and the image from the data capturing apparatus;
operation b) performing a speech-to-text processing and a word count calculation on the audio signal to generate a speech word count, and generating a speech vector based on a word count threshold and the speech word count;
operation c) performing a face detection and a person count calculation on the image to generate a field person count of a plurality of persons in the field, and generating a personnel vector based on a person count threshold and the field person count;
operation d) performing a face recognition and an emotion recognition on the image to generate a personal emotion vector for each of a plurality of the persons in the field, and performing a summation scale adjustment on a plurality of the personal emotion vectors to generate a collective emotion vector; and
operation e) performing an element-wise addition operation on the speech vector, the personnel vector, and the collective emotion vector to generate a field emotion vector, and converting the field emotion vector into a social temperature value indicating a social activity level of a plurality of the persons in the field.

2. The social activity level detection system according to claim 1, wherein in the operation b), the server is configured to perform the following operations:
operation b1) performing the speech-to-text processing on the audio signal to generate a plurality of speech texts, and performing the word count calculation on a plurality of the speech texts to generate the speech word count; and
operation b2) comparing the speech word count with the word count threshold, and generating the speech vector from a two-dimensional emotion model based on a comparison result.

3. The social activity level detection system according to claim 2, wherein in the operation b2), the server is configured to perform the following operations:
when the comparison result indicates that the speech word count is greater than the word count threshold, setting a high-arousal vector on an arousal axis of the two-dimensional emotion model as the speech vector; and
when the comparison result indicates that the speech word count is not greater than the word count threshold, setting a low-arousal vector on the arousal axis of the two-dimensional emotion model as the speech vector.

4. The social activity level detection system according to claim 1, wherein in the operation c), the server is configured to perform the following operations:
operation c1) performing the face detection on the image to recognize a plurality of face objects corresponding to a plurality of the persons in the image, and counting a plurality of the face objects to generate the field person count; and
operation c2) comparing the field person count with the person count threshold, and generating the personnel vector from a two-dimensional emotion model based on a comparison result.

5. The social activity level detection system according to claim 4, wherein in the operation c2), the server is configured to perform the following operations:
when the comparison result indicates that the field person count is greater than the person count threshold, setting a high-arousal vector on an arousal axis of the two-dimensional emotion model as the personnel vector; and
when the comparison result indicates that the field person count is not greater than the person count threshold, setting a low-arousal vector on the arousal axis of the two-dimensional emotion model as the personnel vector.

6. The social activity level detection system according to claim 1, wherein in the operation d), the server is configured to perform the following operations:
operation d1) performing the face recognition on the image to generate an identity information for each of a plurality of the persons in the field;
operation d2) performing the emotion recognition on the image to generate an emotion recognition vector corresponding to each of the identity information; and
operation d3) converting the emotion recognition vector corresponding to each of the identity information into the personal emotion vector of the person corresponding to each of the identity information in a two-dimensional emotion model, respectively.

7. The social activity level detection system according to claim 6, wherein a plurality of elements in the emotion recognition vector corresponding to each of the identity information respectively correspond to a plurality of emotional features, and a plurality of the emotional features respectively correspond to a plurality of feature vectors in the two-dimensional emotion model, and in the operation d3), the server is configured to perform the following operation:
performing a weighted average on a plurality of the feature vectors based on a plurality of the elements in the emotion recognition vector corresponding to each of the identity information to generate the personal emotion vector of the person corresponding to each of the identity information.

8. The social activity level detection system according to claim 1, wherein in the operation e), the server is configured to perform the following operations:
operation e1) generating a vector angle based on the field emotion vector with reference to a negative direction of a valence axis in a two-dimensional emotion model; and
operation e2) determining in which of a plurality of quadrants in the two-dimensional emotion model the vector angle is located, and calculating the social temperature value based on a determination result and the vector angle.

9. The social activity level detection system according to claim 8, wherein in the operation e2), the server is configured to perform the following operation:
calculating an angular difference between the vector angle and a starting angle of the quadrant indicated by the determination result, and calculating the social temperature value based on a number corresponding to the quadrant indicated by the determination result and the angular difference.

10. A social activity level detection method, comprising:
step a) by a server, receiving an audio signal captured in a field and an image captured in the field from a data capturing apparatus;
step b) by the server, performing a speech-to-text processing and a word count calculation on the audio signal to generate a speech word count, and generating a speech vector based on a word count threshold and the speech word count;
step c) by the server, performing a face detection and a person count calculation on the image to generate a field person count of a plurality of persons in the field, and generating a personnel vector based on a person count threshold and the field person count;
step d) by the server, performing a face recognition and an emotion recognition on the image to generate a personal emotion vector for each of a plurality of the persons in the field, and performing a summation scale adjustment on a plurality of the personal emotion vectors to generate a collective emotion vector; and
step e) by the server, performing an element-wise addition operation on the speech vector, the personnel vector, and the collective emotion vector to generate a field emotion vector, and converting the field emotion vector into a social temperature value indicating a social activity level of a plurality of the persons in the field.
